(19) United States
(12) Patent Application Publication
(10) Pub. No.: US 2011/0074339 A1
(43) Pub. Date: Mar. 31, 2011

(54) INFORMATION PROCESSING APPARATUS

(75) Inventor: Makoto MIDORIKAWA, Tokyo (JP)

(73) Assignee: KABUSHIKI KAISHA TOSHIBA, Tokyo (JP)

(21) Appl. No.: 12/895,736

(22) Filed: Sep. 30, 2010

(30) Foreign Application Priority Data
Sep. 30, 2009 (JP) 2009-228902

(51) Int. Cl. H02J 7/00; H02J 1/10

(52) U.S. Cl. 320/106; 307/43

(57) ABSTRACT

An information processing apparatus includes: a case; a battery attachment module which is configured to be provided in the case and to which a first battery and a second battery capable of being charged with a current larger than a current for the first battery are selectively attached; a first connector that is configured to be provided in the battery attachment module and with which the first battery is connected; and a second connector which is configured to be provided in the battery attachment module, with which the second battery is connected, and which is capable of flowing a current larger than a current for the first connector.

### CROSS-REFERENCE TO RELATED APPLICATION

This application is based on and claims priority under 35 U.S.C. §119 from Japanese Patent Application No. 2009-228902 filed on Sep. 30, 2009.

### BACKGROUND

1. Field

The present invention relates to an information processing apparatus capable of mounting a plurality of batteries having different charging currents.

2. Description of the Related Art

In recent years, there is devised a battery capable of being charged with a large current as compared with a commonly used lithium-ion battery (hereinafter referred to as “new type battery”). Since the new type battery has specifications which allow charging by passing a current larger than that for the lithium-ion battery, as a result, it becomes possible to charge the new type battery up to a fully charged condition in a time period shorter than that for the lithium-ion battery.

Consequently, it is considered that, if the lithium-ion battery or the new type battery can be selected and used in accordance with the use of each user, an improvement in convenience for the user is facilitated.

By the way, JP-A 2006-324064 discloses a battery pack of the lithium-ion battery in which a battery determination element for determining the battery type is provided, and the position of its plus terminal is formed at a position different from the position of the plus terminals of battery packs of a nickel-cadmium battery and a nickel-hydrogen battery. A structure is adopted in which the battery pack of the lithium-ion battery can be used in the equipment assuming the use of the battery packs of the nickel-cadmium battery and the nickel-hydrogen battery.

In the technique described in JP-A 2006-324064, the position of the plus terminal is changed in accordance with the battery type so as to be able to use the batteries of different types in combination, but it is not assumed that the configuration itself of a connection terminal and a structure are modified in order to pass a current as large as that for the new type battery.

When consideration is given to the application of the new type battery to an information processing apparatus represented by a notebook personal computer, the amount of current which can be passed through the connection terminal for the commonly used lithium-ion battery at present is not enough so that it is difficult to complete the charging in a short time period.

For example, in order to support both of two types of batteries having different charging currents such as the lithium-ion battery and the new type battery, it is required to have the connection terminal for passing the current larger than the amount of the current which can be passed through the connection terminal for the lithium-ion battery.

### BRIEF DESCRIPTION OF THE DRAWINGS

A general architecture that implements the various features of the invention will now be described with reference to the drawings. The drawings and the associated descriptions are provided to illustrate embodiments of the invention and not limited the scope of the invention.

FIG. 1 is an outer appearance perspective view showing a computer according to an embodiment of the present invention;

FIG. 2 is a perspective view showing a back face of the computer according to the embodiment of the present invention;

FIG. 3 is a block diagram showing the structure of the computer according to the embodiment of the present invention;

FIG. 4 is a view for explaining the structure related to charging control in the embodiment of the present invention in greater detail; and

FIG. 5 is a flow chart showing an example of a procedure for the charging control according to the embodiment of the present invention.

### DETAILED DESCRIPTION OF THE EMBODIMENTS

Various embodiments according to the invention will be described hereinafter with reference to the accompanying drawings.

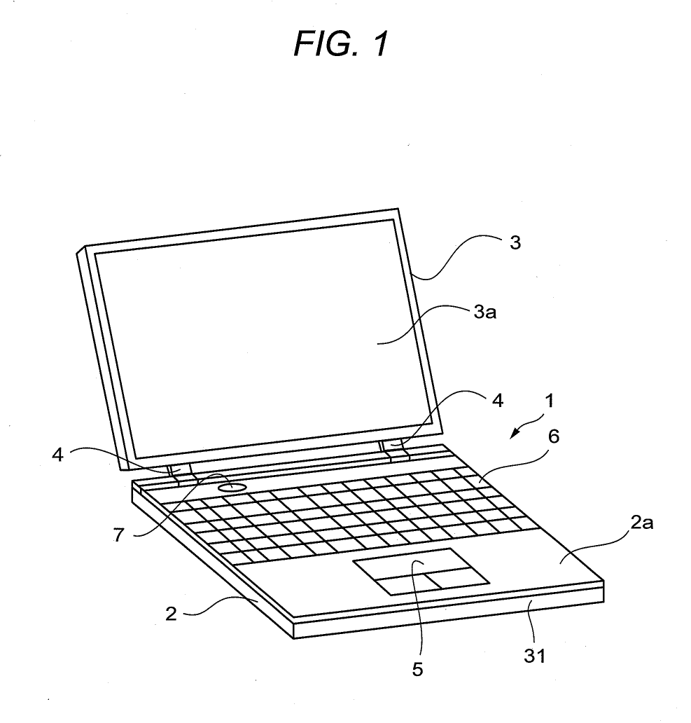

In the present embodiment, the description will be given of a notebook computer as an example of an information processing apparatus. FIG. 1 is an outer appearance perspective view showing the computer according to the embodiment of the present invention.

A computer 1 includes a main body case 2, and a display case 3 is openably and closably attached to the main body case 2 via a hinge 4. The display case 3 can be opened and closed at an open position where an upper face 2a of the main body case 2 is exposed, and at a close position where the upper face 2a of the main body case 2 is covered. In the display case 3, a display device 3a formed of an LCD (Liquid Crystal Display) is incorporated.

In the main body case 2, a circuit board (not shown) on which a plurality of electronic components are mounted is accommodated. On the upper face 2a of the main body case 2, a touch pad 5 and a keyboard 6 are attached as internal input devices. On the upper face 2a of the main body case 2, a power switch 7 for turning ON/OFF the power of the computer 1 is also provided.

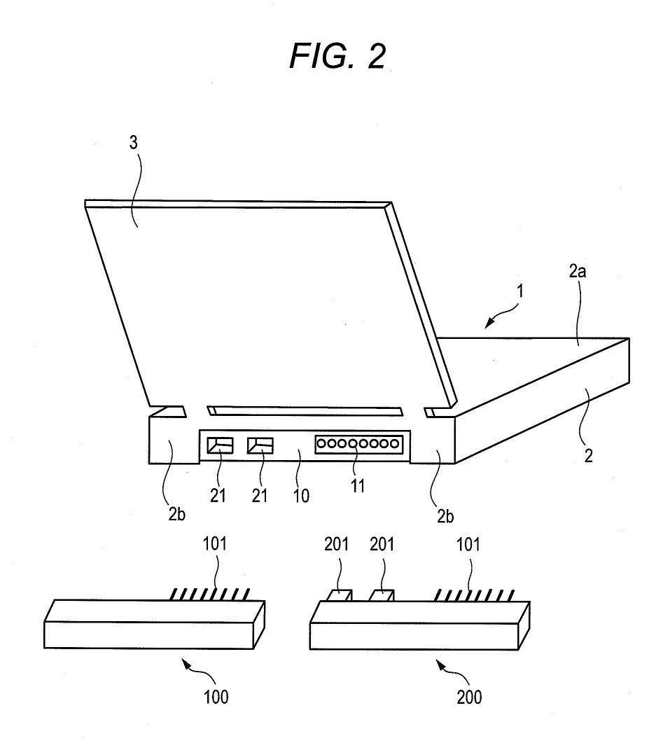

FIG. 2 is a perspective view showing aback face of the computer according to the embodiment of the present invention. On a back face 2b of the main body case 2 of the computer 1, a battery attachment module 10 is provided. To the battery attachment module 10, a first battery 100 or a second battery 200 is selectively attached. In the first battery 100, a first connection terminal 101 is provided. In the second battery 200, second connection terminals 201 are provided. In the present embodiment, the description is based on the assumption that the first connection terminal 101 is also provided in the second battery 200 together with the second connection terminals 201, but it is optional whether or not the first connection terminal 101 is provided in the second battery 200.

In the battery attachment module 10, connectors for connection are provided such that both of the first and second batteries 100 and 200 can be attached to and detached from the battery attachment module 10. Specifically, a first connector 11 to be connected with the connection terminal 101 of the first battery 100, and second connectors 21 to be connected with the connection terminals 201 of the second battery 200 are provided.

In the present embodiment, the second battery 200 is structured to be capable of charging with a current larger than that for the first battery 100. Accordingly, the second battery 200 can be charged more rapidly than the first battery.

Specific figures will be presented as an example. When the charging is performed by using the first connection terminal 101 and the first connector 11, it is assumed that the current of 1.8 A can be passed. At this time, the charging is performed by passing the current of 1.8 A for two hours with respect to the capacity of the first battery 100 of 4000 mAh, and the battery is thereby charged up to 3600 mA (90%).

On the other hand, when the charging is performed by using the second connection terminals 201 and the second connectors 21, it is assumed that the current of 21.6 A can be passed. At this time, since the charging is performed by passing the current of 21.6 A with respect to the capacity of the second battery 200 of 4000 mAh, the battery is charged up to 3600 mA (90%) in only 10 minutes. The charging performed in a relatively short time period by passing such a large current is occasionally referred to as fast charging for convenience sake in the present embodiment.

In order to achieve specifications mentioned above, the connection terminals 201 of the second battery 200 and the second connectors 21 with which the second battery 200 is connected have the configurations of the connection terminals themselves and the connectors themselves which are formed to be thicker than those of the connection terminal 101 of the first battery 100 and the connector 11 with which the first battery 100 is connected. This is for the purpose of allowing the passage of the charging current larger than that for the first battery 100 to the second battery 200.

If possible, instead of forming the configurations of the connection terminals themselves and the connectors themselves to be thick, the connection terminals 201 of the second battery 200 and the second connectors 21 with which the second battery 200 is connected may be formed by using a material which allows the passage of the larger charging current.

In the present embodiment, when the second battery 200 is used, it is also possible to perform the charging in a relatively short time period by passing the larger charging current using the second connection terminals 201 during the charging, and perform discharging from the first connection terminal 101 provided in the second battery 200 during the discharging.

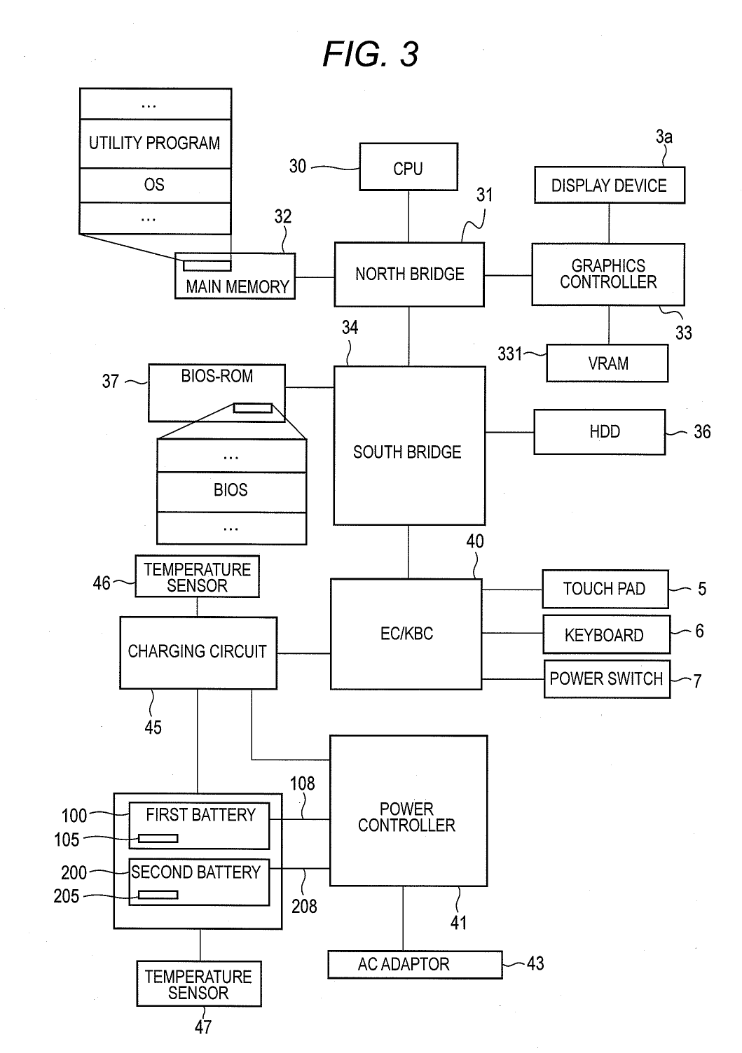

FIG. 3 is a block diagram showing the structure of the computer according to the embodiment of the present invention. In the computer 1, there are provided a CPU 30, a north bridge 31, a main memory (RAM) 32, a graphics controller 33, a south bridge 34, a hard disc drive (HDD) 36, a BIOS-ROM 37, an embedded controller/keyboard controller IC (EC/KBC) 40, the display device 3a, the touch pad 5, the keyboard 6, and the power switch 7.

The CPU 30 is a processor which controls the operations of the individual components of the computer 1. The CPU 30 executes an operating system and various application programs/utility programs which are loaded from the HDD 36 into the main memory (RAM) 32. The main memory (RAM) 32 is also used for the storage of various data buffers.

In addition, the CPU 30 also executes a BIOS (Basic Input Output System) stored in the BIOS-ROM 37. The BIOS is a program for hardware control. The BIOS includes a group of BIOS drivers and, in order to provide a plurality of functions for the hardware control to the operating system and the application programs, each BIOS driver includes a group of a plurality of function execution routines in correspondence to the functions.

In addition, the BIOS loads the operating system into the main memory (RAM) 32 from a storage device such as the HDD 36 to execute processing for bringing the computer 1 into an operable state for a user.

The north bridge 31 is a bridge device for connecting between a local bus of the CPU 30 and the south bridge 34. Further, the north bridge 31 has a function of executing communication with the graphics controller 33 via a PCI Express bus or the like. Furthermore, in the north bridge 31, a memory controller for controlling the main memory (RAM) 32 is embedded.

The graphics controller 33 is a display controller for controlling the display device 3a used as a display monitor of the present computer 1. The graphics controller 33 sends out, to the display device 3a, a video signal in correspondence to display data written in a video memory (VRAM) 331 by the OS or the application programs.

The south bridge 34 is connected with a PCI (Peripheral Component Interconnect) bus and an LPC (Low Pin Count) bus, and performs the control of a PCI device and an LPC device. The HDD (Hard Disc Drive) 36 stores the OS, various application programs/utility programs, and a data file.

The embedded controller/keyboard controller (EC/KBC) 40 is a one-chip microcomputer obtained by integrating an embedded controller for managing a power and a keyboard controller for controlling the touch pad 5 and the keyboard 6. In cooperation with a power controller 41, the EC/KBC 40 executes processing for turning POWER ON/POWER OFF the computer 1 in response to the operation of the power switch 7 by the user. The power controller 41 supplies power to individual components in the computer 1 by using power from the first or second battery 100 or 200 connected with the computer 1, or power supplied from the outside via an AC adaptor 43.

A charging circuit 45 supplies the current for the charging to the first or second battery 100 or 200 attached to the battery attachment module 10.

A temperature sensor 46 is connected with the charging circuit to detect a temperature of the charging circuit 45. The temperature sensor 46 is a sensor provided in order to detect a rise in temperature caused by the heat generation of elements themselves such as an FET and a resistor in the charging circuit 45 resulting from the operation of the charging circuit 45.

On the other hand, a temperature sensor 47 is a sensor for detecting the temperature of the first or second battery 100 or 200 attached to the battery attachment module 10.

It is to be noted that the first battery 100 includes an EEPROM 105 inside the battery. Similarly, the second battery 200 includes an EEPROM 205 inside the battery. The system of the computer 1 is capable of reading information on the first battery 100 from the EEPROM 105, and also reading information on the second battery 200 from the EEPROM 205 via, e.g., the power controller 41.

In the EEPROM 105 of the first battery 100, there is stored the information related to the first battery 100, i.e., ID information for indicating the first battery 100, the capacity of the first battery 100, and a parameter related to charging control such as a completion current value when the first battery 100 is fully charged.

Similarly, in the EEPROM 205 of the second battery 200, there is stored the information related to the second battery 200, i.e., the ID information for indicating the second battery 200, the capacity of the second battery 200, the parameter related to the charging control such as the completion current value when the second battery 200 is fully charged, and information for indicating that the second battery 200 is a battery compatible with the fast charging.

The power controller 41 is capable of acquiring the information stored in the EEPROM 105 from the first battery 100 by performing communication using an I2C bus 108. The power controller 41 is similarly capable of acquiring the information stored in the EEPROM 205 from the second battery 200 by performing communication using an I2C bus 208.

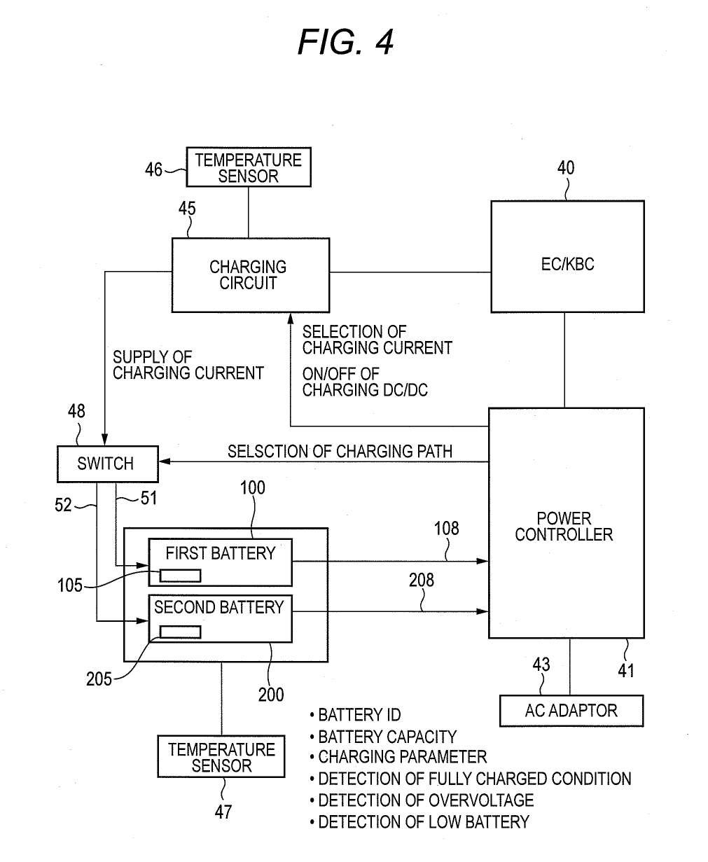

FIG. 4 is a view for explaining the structure related to the charging control in the embodiment of the present invention in greater detail. It is to be noted that, with regard to matters which have already been explained in the description related to FIG. 3, a repeated description thereof is occasionally omitted.

The power controller 41 reads the information related to the battery from the first battery 100 attached to the battery attachment module 10 through the I2C bus 108, or from the second battery 200 through the I2C bus 208. In addition to the acquisition of the ID information on the battery, the capacity of the battery, the parameter related to the charging control of the battery, and the information for indicating that the battery is compatible with the fast charging which have been mentioned in the above description, the power controller 41 can also detect that the battery is fully charged, that an overvoltage of the battery is occurring, and that the battery is in a low-battery state where the capacity thereof is lower than a given threshold value.

The power controller 41 selects the charging current for charging the battery based on the information read through the I2C bus from the first battery 100 or the second battery 200, and reports the passage of the charging current to the charging circuit 45.

At this time, the power controller 41 sends an ON/OFF signal of a charging path to a switch 48. In accordance with the signal sent from the power controller 41 to the switch 48, it is selected whether the charging current is supplied to the first battery 100 through a first charging path 51, or the charging current is supplied to the second battery 200 through a second charging path 52.

When the charging circuit 45 receives the report on the passage of the charging current to the battery from the power controller 41, the charging circuit 45 supplies the charging current to the battery attached to the battery attachment module 10. When the first battery 100 is attached, the charging current suitable for the first battery 100 is supplied through the first charging path 51, while when the second battery 200 is attached, the charging current suitable for the second battery 200 is supplied through the second charging path 52.

Thus, in accordance with the type of the battery connected with the battery attachment module 10, the charging current to be supplied to the battery is selected. In other words, when the first battery 100 is attached, the charging current suitable for the first battery 100 is supplied, while when the second battery 200 is attached, the charging current larger than that for the first battery 100 is supplied. In the computer 1 of the present embodiment, it becomes possible to handle both of the charging for the first battery 100 and the fast charging for the second battery 200.

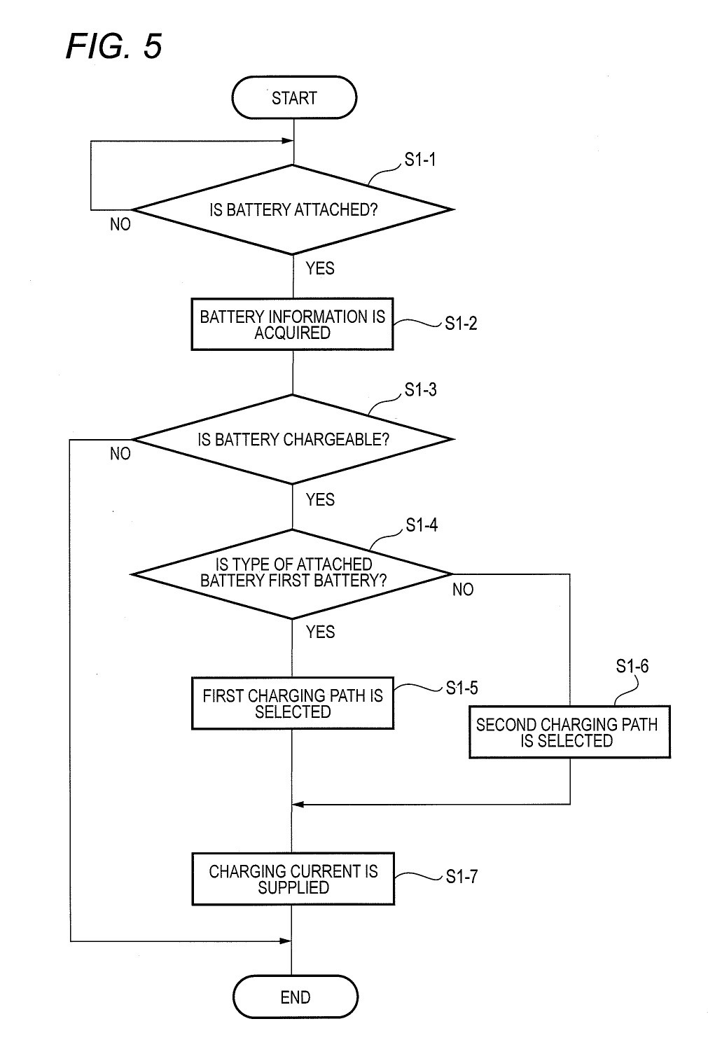

FIG. 5 is a flow chart showing an example of a procedure for the charging control according to the embodiment of the present invention. First, the power controller 41 performs the communication utilizing the I2C buses to monitor whether or not the first battery 100 or the second battery 200 is attached to the battery attachment module 10 (step 1-1).

When it is detected that the first battery 100 or the second battery 200 is attached (Yes in the step 1-1), the ID information on the battery, the capacity of the battery, the parameter related to the charging control of the battery, and the information for indicating that the battery is compatible with the fast charging are acquired from the attached battery (step 1-2). At this time, it is detected whether or not the battery is fully charged, whether or not the overvoltage of the battery is occurring, and whether or not the battery is in the low-battery state where the capacity thereof is lower than the given threshold value.

The power controller 41 determines whether or not the battery attached to the battery attachment module 10 is chargeable based on the acquired information items (step 1-3). This determination is performed based on the charging capacity of the battery and the temperature of the battery. Examples of the determination criterion include whether or not the battery is in a fully charged condition, whether or not the battery is in an overcharged condition, and whether or not the temperature of the battery is in a range of normal temperatures. As the result of the determination, when the battery is not chargeable (No in the step 1-3), the charging for the battery is not performed. At this time, an error report may be sent to the system of the computer 1 from the power controller 41.

When there is no particular abnormality in the battery attached to the battery attachment module 10, and the battery is chargeable (Yes in the step 1-3), the type of the battery is determined based on the ID information on the battery acquired from the attached battery (step 1-4). When the attached battery is the first battery 100 (Yes in the step 1-4), the first charging path is selected (step 1-5), and the charging current suitable for the first battery 100 is supplied through the first charging path 51 (step 1-7). On the other hand, when the attached battery is the second battery 200 (No in the step 1-4), the second charging path is selected (step 1-6), and the charging current suitable for the second battery 200 is supplied through the second charging path 52 (step 1-7).

As has been described thus far, according to the embodiment of the present invention, it is possible to provide the information processing apparatus which allows the support for both of the first battery and the second battery having the charging current larger than that for the first battery.

The present invention is not limited to the above-described embodiment, and can be variously modified without departing from the gist thereof.

What is claimed is:

1. An information processing apparatus comprising:
a case;
a battery attachment module in the case and to which are selectively attached a first battery and a second battery capable of being charged with a current larger than a current for the first battery;
a first connector in the battery attachment module configured to connect to the first battery; and
a second connector in the battery attachment module configured to connect to the second battery, and to flow a current larger than a current for the first connector.

2. The apparatus of claim 1, further comprising:
an identification information reader configured to read battery identification information from the battery connected with the battery attachment module; and
a power controller configured to control charging for the connected battery by switching between a first charging path supplying power to the first battery from the first connector, and a second charging path supplying the power to the second battery from the second connector, on a basis of the battery identification information read by the identification information reader.

3. The apparatus of claim 2, wherein
the power controller is configured to set a charging control parameter for the first battery or the second battery to charge, based on the battery identification information read by the identification information reader.

4. The apparatus of claim 3, wherein
the power controller configured to determine whether the battery attached to the battery attachment module is chargeable from a charging capacity of the battery included in the battery identification information.
